(19) United States
(12) Patent Application Publication
(10) Pub. No.: US 2003/0070073 A1
(43) Pub. Date: Apr. 10, 2003

(54) Card authenticating apparatus

(75) Inventor: Tsuyoshi Miyano, Sunnyvale, CA (US)

Correspondence Address: BEYER WEAVER & THOMAS LLP, P.O. BOX 778, BERKELEY, CA, 94704-0778, US

(73) Assignee: ALPS Electric Co., Ltd.

(21) Appl. No.: 09/974,169

(22) Filed: Oct. 9, 2001

(51) Int. Cl. H04L 9/00

(52) U.S. Cl. 713/168

(57) ABSTRACT

An apparatus for authenticating a card containing first and second images which is covered by lenticular lenses includes an optical input device, a data storage section, and a processor. The optical input section is operable to generate first data representing the first image and generate second data representing the second image. The data storage section is operable to store reference data representing a reference image. The processor is operable to authenticate the card based on the first data, the second data, and the reference data. The optical input section is operable to receive the first and second images through the lenticular lenses.

### BACKGROUND OF THE INVENTION

The present invention relates to a card authenticating apparatus, and more specifically, to apparatus and methods for retrieving images contained in a card, and authenticating the card based on the retrieved images.

Various identification cards are used today in a variety of situations. Some identification cards include holographic images thereon, and others include integrated circuit (IC) chips therein. Cards with holographic images have to be checked by a human inspector, and thus, authentication of the card is not always accurate due to recognition errors by the naked eye. On the other hand, cards having IC chips are vulnerable to unauthorized access and copying by probing the chips and reverse-engineering logic functionality of the chips.

In view of these and other issues, it would be desirable to have a technique allowing a card authenticating apparatus to determine authenticity of an identification card with high precision without sacrificing security of information contained in the card.

### SUMMARY OF THE INVENTION

According to various embodiments of the present invention, two separate images are retrieved from a card through lenticular lenses provided on the card, and the retrieved card images are compared with reference images for authenticating the card. If the scanned images match the reference images, the card is authenticated.

In some embodiments, a card authenticating apparatus for authenticating a card containing first and second images which is covered by lenticular lenses includes an optical input device, a data storage section, and a processor. The optical input section is operable to generate first data representing the first image and generate second data representing the second image. The data storage section is operable to store reference data representing a reference image. The processor is operable to authenticate the card based on the first data, the second data, and the reference data. The optical input section is operable to receive the first and second images through the lenticular lenses.

In some embodiments, the reference data includes first reference data representing a first reference image, and second reference data representing a second reference image. The processor is operable to compare the first data with the first reference data, and compare the second data with the second reference data.

In some alternative embodiments, the processor is operable to combine the first and second data into combined data, and compare the combined data with the reference data.

A further understanding of the nature and advantages of the present invention may be realized by reference to the remaining portions of the specification and the drawings.

### BRIEF DESCRIPTION OF THE DRAWING

The invention, together with further objects and advantages thereof, may best be understood by reference to the following description taken in conjunction with the accompanying drawings in which:

FIG. 1 is a block diagram of a specific embodiment of a card authenticating apparatus 100 according to the present invention.

FIG. 2 is a plan view of an original image from which the images on the card are created used for the specific embodiment of the card authenticating apparatus according to the present invention.

FIG. 3 is a plan view of another original image from which the images on the card are created used for the specific embodiment of the card authenticating apparatus according to the present invention.

FIG. 4 is a plan view of a combined original image which is printed on the card used for the specific embodiment of the card authenticating apparatus according to the present invention.

FIG. 5 is a plan view of scanned image which is received by the optical input device through the lenticular lenses used for the specific embodiment of the card authenticating apparatus according to the present invention.

FIG. 6 is a plan view of scanned image which is received by the optical input device through the lenticular lenses used for the specific embodiment of the card authenticating apparatus according to the present invention.

FIG. 7 is a plan view of a combined scanned image used for the specific embodiment of the card authenticating apparatus according to the present invention.

FIG. 8 is a flowchart illustrating a specific embodiment of a method of authenticating a card according to the present invention.

FIG. 9 is a flowchart illustrating an alternative embodiment of a method of authenticating a card according to the present invention.

### DETAILED DESCRIPTION OF SPECIFIC EMBODIMENTS

Various embodiments of the present invention will now be described in detail with reference to the drawings, wherein like elements are referred to with like reference labels throughout.

Various embodiments of the present invention scan two separate images from a card through lenticular lenses provided on the card, and compare the scanned images with reference images for authenticating the card. If the scanned images match the reference images, the card is authenticated. Each of the two separate images is divided into narrow stripes, which are then positioned alternately. Thus, the divided images on the card cannot be recognized by the naked eye. Nor a photocopier can make a copy of the images through the lenticular lenses.

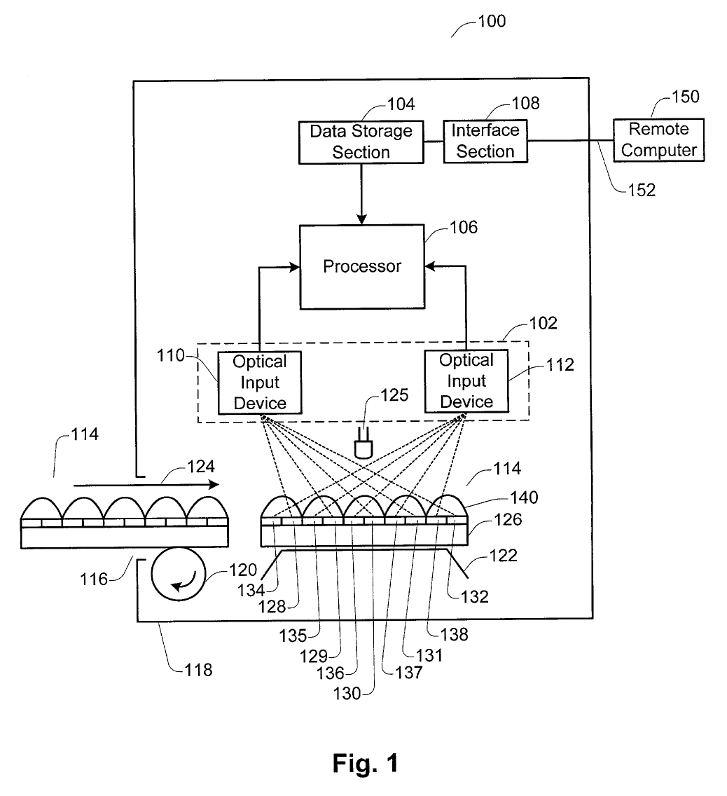

FIG. 1 is a block diagram of a specific embodiment of a card authenticating apparatus 100 according to the present invention. The card authenticating apparatus 100 includes an optical input section 102, a data storage section 104, a processor 106, and an interface section 108. The optical input section 102 includes optical input devices 110 and 112.

A card 114 is inserted into an opening 116 provided on a housing 118 of the card authenticating apparatus 100. A feeding mechanism 120 feeds the card 114 toward a card holder 122 along a feeding direction 124. The feeding mechanism 120 is appropriately controlled by the processor 106 in order to position the card 114 in a suitable location on the card holder 122 during authentication, and remove the card 114 after the authentication. The feeding mechanism 120 may be any suitable mechanism including, for example, a roller actuated by a stepping motor.

An illuminating device 125 emits light onto the card 114 positioned on the card holder 122 so that the light from the illuminating device 125 is reflected by the card 114 and the reflected light is received by the optical input devices 110 and 112. The illuminating device 125 may be any suitable device emitting light which can be detected by the optical input devices 110 and 112 such as a light emitting diode, a lamp, an electroluminescent panel, or the like.

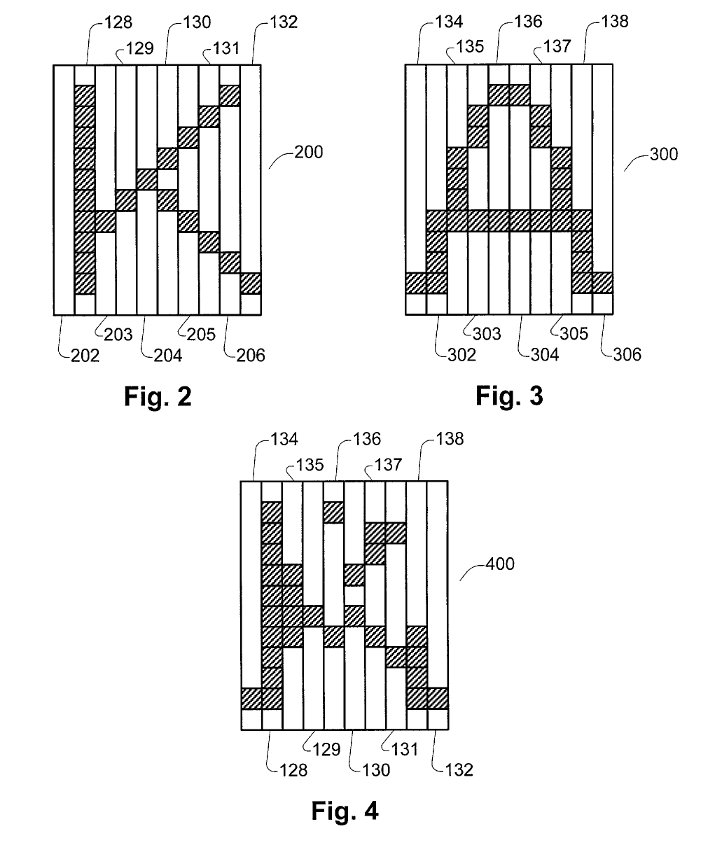

The card 114 includes a base layer 126, images 128-132 and 134-138, and lenticular lenses 140. In this specific embodiment, the base layer 126 is made from materials including suitable polymers such as PVC, PC, ABS, PPS and PETG. The thickness of the base layers 126 ranges from about 0.5 mm to about 1.0 mm. On top of the base layer 126, the images 128-132 and 134-138 are provided. Each of the images 128-132 and 134-138 is a set of stripes created by dividing original images as described in detail later referring to FIGS. 2-4. The images 128-132 and 134-138 are provided on the base layer 126 by, for example, printing ink materials using any suitable technique including thermal transfer printing, ink jet printing, electrophotographic printing, or the like.

The first optical input device 110 is positioned so that light reflected from the images 128-132 passes through a first side of the lenticular lenses 140 to the first optical input device 110, as shown. The second optical input device 112 is positioned so that light reflected from images 134-138 passes through a second side of the lenticular lenses 140 to the second optical input device 112. This light may come from the illuminating device 125. This may be accomplished by positioning the illuminating device midway between the first optical input device 110 and the second optical input device 112, and by placing the image and lenticular lenses 140 midway between the first optical input device 110 and the second optical input device 112.

In some embodiments, the optical input devices 110 and 112 are symmetrically positioned with respect to a plane which is perpendicular to a plane including the card 114 and parallel with the longitudinal direction of the lenticular lenses 140. In further specific embodiments, the illuminating device 125 is positioned substantially on the plane which is perpendicular to a plane including the card 114 and parallel with the longitudinal direction of the lenticular lenses 140.

The lenticular lenses 140 are provided on top of the images 128-132 and 134-138. The lenticular lenses 140 are made from any suitable material such as PVC, PC, ABS, PPS and PETG. The lenticular lenses 140 are typically made into a sheet having ridge portions, and then affixed onto the card 114 by, for example, a transparent adhesive material. In some embodiments, each ridge portion of the lenticular lenses 140 has a cross-section of a parabolic, circular, or rounded triangular shape. In this specification, the term “lenticular lenses” includes barrier lenses. The barrier lenses is typically made from a transparent sheet whose thickness is about 1 mm having parallel black lines printed on one of its surfaces. Although the specific embodiment utilizes lenticular lenses, it should be appreciated that the lenticular lenses 140 may be any suitable optical material which allows the optical input device 110 to receive one set of stripe images 128-132 and the optical input device 112 to receive the stripe images 134-138 therethrough.

The optical input device 110 receives the images 128-132 through the lenticular lenses 140 while the optical input device 112 receives the images 134-138 through the lenticular lenses 140. The optical input devices 110 and 112 may be any suitable devices which is operable to scan the images on the card 114 through the lenticular lenses 140 such as charge coupled devices (CCD). The distance between the card 114 and the optical input devices 110 and 112 may be adjusted appropriately based on the characteristics of the optical input devices 110 and 112, and the lenticular lenses 140. The optical input devices 110 and 112 may be line CCD sensors, or two-dimensional CCD sensors. The optical input devices 110 and 112 generate data representing the images 128-132 and 134-138, respectively, and output the data representing the images 128-132 and 134-138 to the processor 106.

The data storage section 104 stores reference data representing a reference image. The processor 106 retrieves the reference data from the data storage section 104, receives the data representing the images 128-132 and 134-138 from the optical input devices 110 and 112, and compares the data representing the images 128-132 and 134-138 with the reference data in order to authenticate the card 114. If the data representing the images 128-132 and 134-138 matches the reference data, the card 114 is determined to be authentic. Conversely, if the data representing the images 128-132 and 134-138 does not match the reference data, the card 114 is determined not to be authentic. In some embodiments, the processor 106 may determine the authenticity of the card 114 with some appropriate tolerance. In other words, depending on the scanning precision of the card 114 through the lenticular lenses 140, and how stringent the authenticity of the card 114 should be checked, some errors or differences between the images 128-132 and 134-138 and the reference data can be neglected.

FIGS. 2 and 3 are plan views of the original images 200 and 300 from which the images 128-132 and 134-138 on the card 114 are created used for the specific embodiment of the card authenticating apparatus 100 according to the present invention. The image 200 is divided into, for example, ten stripe images 128-132 and 202-206. Similarly, the image 300 is divided into, for example, ten stripe images 134-138 and 302-306.

FIG. 4 is a plan view of a combined original image 400 which is printed on the card 114 used for the specific embodiment of the card authenticating apparatus 100 according to the present invention. The combined original image 400 is created by alternately combining the stripe images 200 and 300. More specifically, the image 400 is generated by combining the stripe images 128-132 and 134-138 while decimating the stripe images 202-206 and 302-306. The resulting image 400 is printed on the base layer 126 by a suitable method as described above.

Although the images 200, 300 and 400 are jagged in this specific embodiment, smooth images may be utilized. The unit size of the stripe images 128-132, 134-138, 202-206, and 302-306 corresponds to that of the optical input devices 110 and 112 when the images are scanned through the lenticular lenses 140. Although the width of the stripe images 128-132, 134-138, 202-206, and 302-306 is one pixel of the optical input devices 110 and 112 in this specific embodiment, it should be appreciated that the width of the stripe images may be more than two pixels of the optical input devices 110 and 112. Although the stripe images 202-206 and 302-306 are decimated and are not used in creating the combined original image 400 in this specific embodiment, all of the stripe images 128-132, 134-138, 202-206, and 302-306 may be utilized to create the image 400. In such a case, the resulting image 400 would have twenty stripe images 128-132, 134-138, 202-206, and 302-306 since no stripe images are discarded.

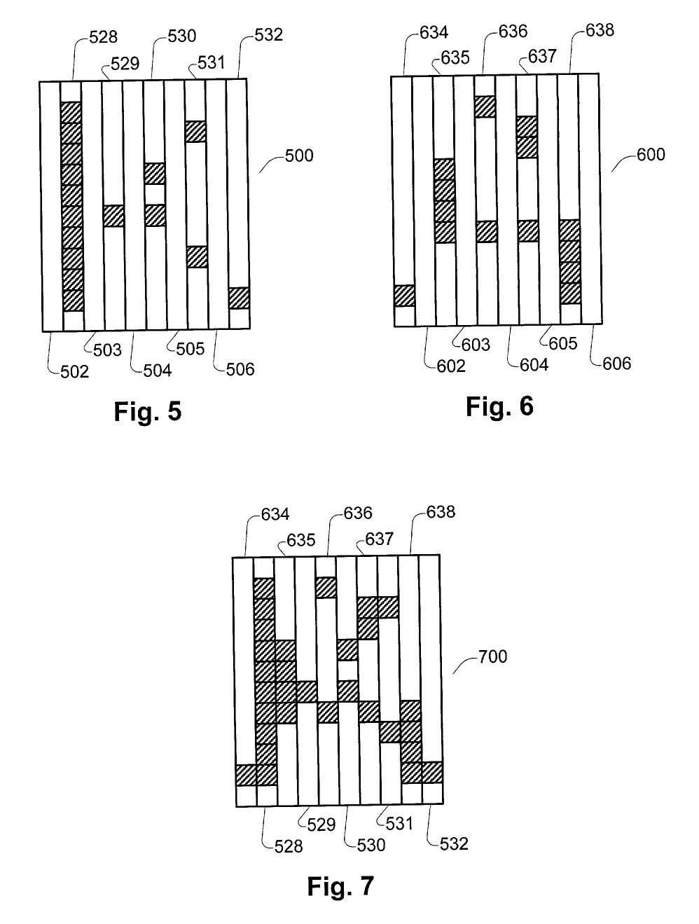

FIGS. 5 and 6 are plan views of scanned images 500 and 600 which are received by the optical input devices 110 and 112 through the lenticular lenses 140 used for the specific embodiment of the card authenticating apparatus 100 according to the present invention. The optical input device 110 scans the card 114 through the lenticular lenses 140, thereby retrieving scanned stripe images 528-532, and does not receive the stripe images 134-138 due to the characteristics of the lenticular lenses 140. Conversely, the optical input device 112 scans the card 114 through the lenticular lenses 140, thereby retrieving scanned stripe images 634-638, and does not receive the stripe images 128-132 due to the characteristics of the lenticular lenses 140. Consequently, the scanned images 500 and 600 include blank stripe images 502-506 and 602-606, respectively.

Referring back to FIG. 1, in some embodiments, the data storage section 104 stores the original images 200 and 300. The processor 106 compares the scanned images 500 and 600 with the original images 200 and 300, respectively. Specifically, the processor 106 compares the scanned stripe images 528-532 shown in FIG. 5 with the original stripe images 128-132 shown in FIG. 2, and compares the scanned stripe images 634-638 shown in FIG. 6 with the original stripe images 134-138 shown in FIG. 3. In this embodiment, the blank stripe images 502-206 and 602-606 are ignored during this comparison process.

FIG. 7 is a plan view of a combined scanned image 700 used for the specific embodiment of the card authenticating apparatus 100 according to the present invention. The processor 106 receives the scanned stripe images 502-506 and 528-532 from the optical input device 110, and receives the scanned stripe images 602-606 and 634-638 from the optical input device 112. Then, the processor 106 combines the images 528-532 and 634-638 alternately, and generates the combined scanned image 700. In a case where the processor 106 creates the combined scanned image 700, the data storage section 104 stores the combined original image 400. The processor 106 compares the combined scanned image 700 with the combined original image 400. Specifically, the processor 106 compares the scanned stripe images 528-532 and 634-638 shown in FIG. 7 with the original stripe images 128-132 and 134-138 shown in FIG. 4.

The interface section 108 interfaces with the data storage section 104 and a remote computer 150 external to the card authenticating apparatus 100 through a network 152. In some embodiments, the data storage section 104 may retrieve at least a part of data representing the original images 200, 300 and 400 from the remote computer 150 through the network 152. In such an embodiment, retrieving at least a part of the original images from the external computer enables further security and flexibility of the card authenticating apparatus 100 since the original images are stored in a secured, remote place, thus avoiding unauthorized access to the original image data in the data storage section 104.

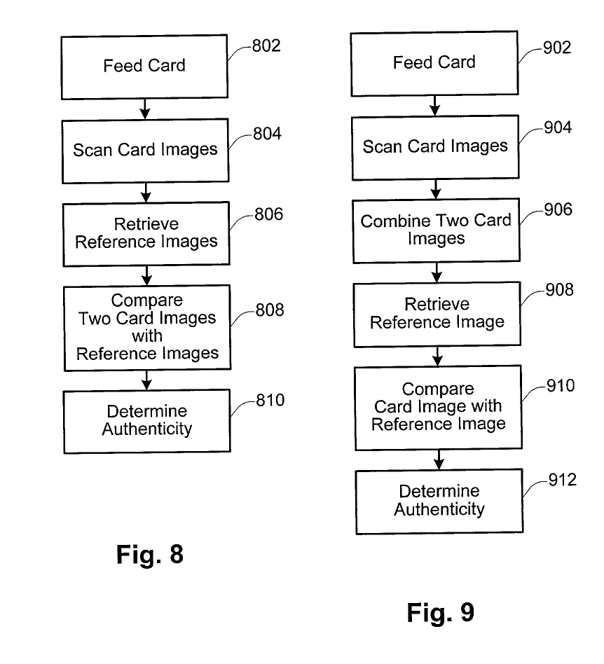

FIG. 8 is a flowchart illustrating a specific embodiment of a method of authenticating a card according to the present invention. At 802, the card authenticating apparatus 100 feeds the card 114 by the feeding mechanism 120. At 804, the optical input devices 110 and 112 scan the card 114. Specifically, the optical input devices 110 and 112 generate data representing the scanned stripe images 500 and 600, respectively. At 806, the processor 106 retrieves from the data storage section 104 data representing the original stripe images 200 and 300 as reference images. At 808, the processor 106 compares the data representing the scanned stripe images 500 and 600 with data representing the reference images 200 and 300, respectively. At 810, the processor 106 determines authenticity of the card 114 based on the difference between the data representing the scanned stripe image 500 and the data representing the reference image 200, and on the difference between the data representing the scanned stripe image 600 and the data representing the reference image 300.

FIG. 9 is a flowchart illustrating an alternative embodiment of a method of authenticating a card according to the present invention. At 902, the card authenticating apparatus 100 feeds the card 114 by the feeding mechanism 120. At 904, the optical input devices 110 and 112 scan the card 114. Specifically, the optical input devices 110 and 112 generate data representing the scanned stripe images 500 and 600, respectively. At 906, the processor 106 combines the data representing the scanned stripe image 500 and the data representing the scanned stripe image 600, and generates combined data representing the combined scanned image 700. At 908, the processor 106 retrieves from the data storage section 104 data representing the combined original stripe image 400 as a reference image. At 910, the processor 106 compares the data representing the scanned stripe image 700 with the data representing the reference image 400. At 912, the processor 106 determines authenticity of the card 114 based on the difference between the data representing the combined scanned stripe image 700 and the data representing the reference image 400.

The card authenticating apparatus 100 may, for example, control an external device (not shown) based on the authenticity of the card 114 determined by the processor 106.

The functionality of the embodiments of the present invention can be implemented by any combination of software and/or hardware. For example, the embodiments can be implemented in an operating system (e.g., Windows NT) kernel, in a separate user process, in a library package bound into network applications, on a specially constructed machine, or on a network interface card. In one specific embodiment of the invention, the operations performed by the embodiments of the invention are partially implemented in a personal computer software or a server computer software. It is also partially implemented in client code on a device which is connected with the server via the network. Both components may be implemented in an operating system or in an application running on an operating system.

Embodiments of the present invention relate to an apparatus and a method for performing the above-described card authenticating operations. This apparatus may be specially constructed (or designed) for the required purposes, or it may be a general-purpose computer selectively activated or configured by a computer program stored in the computer. The processes presented herein are not inherently related to any particular computer or other apparatus. In particular, various general-purpose machines may be used with programs written in accordance with the teachings herein, or it may be more convenient to construct a more specialized apparatus to perform the required method operations.

In addition, embodiments of the present invention further relate to computer program products using computer readable media that include program instructions for performing various computer-implemented operations. The media may also include, alone or in combination with the program instructions, data files, data structures, tables, and the like. The media and program instructions may be those specially designed and constructed for the purposes of the present invention, or they may be of the kind well known and available to those having skill in the computer software arts. Examples of computer-readable media include magnetic media such as hard disks, floppy disks, and magnetic tape; optical media such as CD-ROM disks; magneto-optical media such as mini disks, floptical disks; and hardware devices that are specially configured to store and perform program instructions, such as ROMs (read-only memories) and RAMs (random access memories). The media may also be a transmission medium such as optical or metallic lines, wave guides, etc. including a carrier wave transmitting signals specifying the program instructions, data structures, etc. The carrier wave may be an RF (Radio Frequency) signal, an infrared ray, a microwave, and other suitable carrier. Examples of program instructions include both machine code, such as produced by a compiler, and files containing higher level code that may be executed by the computer using an interpreter. It is contemplated that such a computer program product may be distributed as a removable media with accompanying printed or electronic documentation, e.g., shrink wrapped software, preloaded with a computer system, e.g., on a system ROM or a fixed disk, or distributed from a server or electronic bulletin board over a network, e.g., the Internet or World Wide Web.

Although only a few embodiments of the present invention have been described in detail, it should be understood that the present invention may be embodied in many other specific forms without departing from the spirit or scope of the invention. Therefore, it should be apparent that the above described embodiments are to be considered as illustrative and not restrictive, and the invention is not to be limited to the details given herein, but may be modified within the scope of the appended claims.

What is claimed is:

1. An apparatus for authenticating a card containing first and second images which is covered by lenticular lenses, comprising:
an optical input section operable to generate first data representing the first image and generate second data representing the second image;
a data storage section operable to store reference data representing a reference image; and
a processor operable to authenticate the card based on the first data, the second data, and the reference data, wherein
the optical input section is operable to receive the first and second images through the lenticular lenses.

2. The apparatus of claim 1, wherein the optical input section includes a first optical input device operable to generate the first data, and a second optical input device operable to generate the second data.

3. The apparatus of claim 2, wherein the reference data includes first reference data representing a first reference image, and second reference data representing a second reference image, and wherein the processor is operable to compare the first data with the first reference data, and compare the second data with the second reference data.

4. The apparatus of claim 3, wherein the first optical input device includes a first CCD device, and the second optical input device includes a second CCD device.

5. The apparatus of claim 4, further comprising an interface unit through which the data storage section is operable to retrieve at least a part of the reference data from an external remote computer.

6. The apparatus of claim 2, wherein the processor is operable to combine the first and second data into combined data, and compare the combined data with the reference data.

7. The apparatus of claim 6, wherein the first optical input device includes a first CCD device, and the second optical input device includes a second CCD device.

8. The apparatus of claim 7, further comprising an interface unit through which the data storage section is operable to retrieve at least a part of the reference data from an external remote computer.

9. An apparatus for authenticating a card containing first and second images which is covered by lenticular lenses, comprising:
means for generating first data representing the first image and generate second data representing the second image;
means for storing reference data representing a reference image; and
means for authenticating the card based on the first data, the second data, and the reference data, wherein
the means for generating the first and second data is operable to receive the first and second images through the lenticular lenses.

10. A method of authenticating a card containing first and second images which is covered by lenticular lenses, comprising:
receiving the first and second images through the lenticular lenses;
generating first data representing the first image and generate second data representing the second image;
storing reference data representing a reference image; and
authenticating the card based on the first data, the second data, and the reference data.

11. The method of claim 10, wherein the generating the first and second data is performed by a first optical input device operable to generate the first data, and a second optical input device operable to generate the second data.

12. The method of claim 11, wherein the reference data includes first reference data representing a first reference image, and second reference data representing a second reference image, and wherein the authenticating is performed by comparing the first data with the first reference data, and by comparing the second data with the second reference data.

13. The method of claim 12, wherein the first optical input device includes a first CCD device, and the second optical input device includes a second CCD device.

14. The method of claim 13, further comprising retrieving at least a part of the reference data from an external remote computer.

15. The method of claim 11, wherein the authenticating is performed by combining the first and second data into combined data, and by comparing the combined data with the reference data.

16. The method of claim 15, wherein the first optical input device includes a first CCD device, and the second optical input device includes a second CCD device.

17. The method of claim 16, further comprising retrieving at least a part of the reference data from an external remote computer.
